(19) United States
(12) Patent Application Publication
(10) Pub. No.: US 2025/0069439 A1
(43) Pub. Date: Feb. 27, 2025

(54) PROCESSING SYSTEM, PROCESSING METHOD, AND STORAGE MEDIUM

(71) Applicant: KABUSHIKI KAISHA TOSHIBA, Tokyo (JP)

(72) Inventors: Hirotomo OSHIMA, Yokohama Kanagawa (JP); Takanori YOSHII, Kawasaki Kanagawa (JP); Takehiro KATO, Yokohama Kanagawa (JP); Yasuo NAMIOKA, Nerima Tokyo (JP)

(21) Appl. No.: 18/605,592

(22) Filed: Mar. 14, 2024

(30) Foreign Application Priority Data
Aug. 23, 2023 (JP) 2023-135834

(51) Int. Cl. G06V 40/20; G06T 7/60

(52) U.S. Cl. CPC G06V 40/20; G06T 7/60; G06T 2207/20072; G06T 2207/20084; G06T 2207/30196

(57) ABSTRACT

According to one embodiment, a processing system generates first graph data based on a pose of a worker. The pose is estimated based on a first image of the worker. The first graph data includes a plurality of first nodes corresponding respectively to a plurality of joints of the worker, and a plurality of first edges corresponding respectively to a plurality of skeletal parts of the worker. The processing system inputs the first graph data to a neural network including a graph neural network (GNN). The processing system estimates a task being performed by the worker, by using a result output from the neural network.

### CROSS-REFERENCE TO RELATED APPLICATIONS

This application is based upon and claims the benefit of priority from Japanese Patent Application No. 2023-135834, filed on Aug. 23, 2023; the entire contents of which are incorporated herein by reference.

### FIELD

Embodiments described herein relate generally to a processing system, a processing method, and a storage medium

### BACKGROUND

There is a system that automatically estimates a task being performed. Technology that enables the system to estimate the task with higher accuracy is desirable.

### BRIEF DESCRIPTION OF THE DRAWINGS

FIG. 1 is a schematic view showing a configuration of a processing system according to an embodiment;

FIG. 2A is a schematic view showing a worker and an article, and FIG. 2B is an example of an image acquired by the imaging device;

FIG. 3 illustrates an estimation result of a pose;

FIG. 4 is a schematic view illustrating the structure of the first graph data;

FIG. 5 is a schematic view illustrating the structure of a neural network;

FIG. 6A illustrates the specific structure of the first graph data, and FIG. 6B illustrates a feature vector;

FIGS. 7A to 7C show specific examples of feature vectors;

FIG. 8 is a flowchart showing an example of a processing method according to the embodiment;

FIG. 9 is a schematic view illustrating an output result of the processing system according to the embodiment;

FIG. 10 is a schematic view illustrating another structure of the graph data;

FIGS. 11A and 11B are schematic views illustrating another structure of the graph data;

FIG. 12 is a schematic view illustrating another structure of a neural network;

FIG. 13 is a schematic view illustrating the specific structure of the LSTM network;

FIG. 14 is a table showing the accuracy of the estimation results of the tasks;

FIG. 15 is a table illustrating the tasks performed;

FIG. 16 is a schematic view illustrating a structure of the first graph data;

FIG. 17 is a schematic view illustrating a structure of the first graph data;

FIG. 18 is a schematic view illustrating another structure of a neural network;

FIG. 19 is a schematic view illustrating another structure of a neural network;

FIG. 20 is a flowchart showing another example of the processing method according to the embodiment; and

FIG. 21 is a schematic view illustrating a hardware configuration.

### DETAILED DESCRIPTION

According to one embodiment, a processing system generates first graph data based on a pose of a worker. The pose is estimated based on a first image of the worker. The first graph data includes a plurality of first nodes corresponding respectively to a plurality of joints of the worker, and a plurality of first edges corresponding respectively to a plurality of skeletal parts of the worker. The processing system inputs the first graph data to a neural network including a graph neural network (GNN). The processing system estimates a task being performed by the worker, by using a result output from the neural network.

Various embodiments are described below with reference to the accompanying drawings. The drawings are schematic and conceptual; and the relationships between the thickness and width of portions, the proportions of sizes among portions, etc., are not necessarily the same as the actual values. The dimensions and proportions may be illustrated differently among drawings, even for identical portions. In the specification and drawings, components similar to those described previously or illustrated in an antecedent drawing are marked with like reference numerals, and a detailed description is omitted as appropriate.

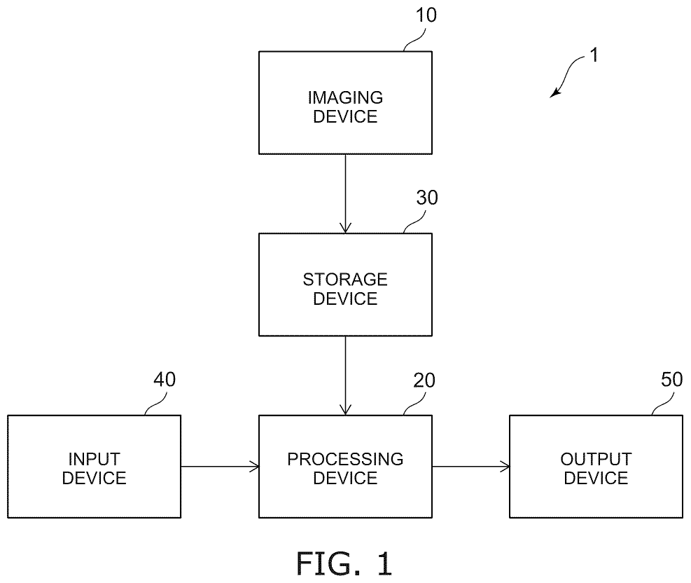

FIG. 1 is a schematic view showing a configuration of a processing system according to an embodiment.

The processing system according to the embodiment is used to estimate a task performed by a worker based on an image. As shown in FIG. 1, the processing system 1 includes an imaging device 10, a processing device 20, a storage device 30, an input device 40, and an output device 50.

The imaging device 10 acquires the image by imaging the worker performing the task. The processing device 20 estimates the task being performed by processing the acquired image. The storage device 30 stores data necessary for the processing by the processing device 20 in addition to images or video images. The input device 40 is used by a user to input data to the processing device 20. The data that is obtained by the processing is output by the processing device 20 to the output device 50 so that the user can recognize the data.

Processing by the processing system 1 will now be described with reference to specific examples.

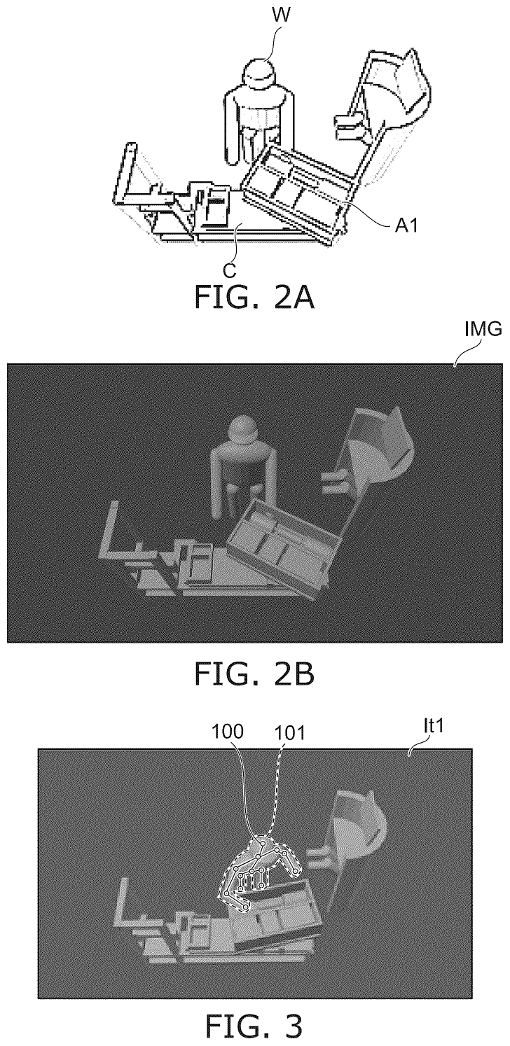

FIG. 2A is a schematic view showing a worker and an article. FIG. 2B is an example of an image acquired by the imaging device. FIG. 3 illustrates an estimation result of a pose.

For example, as shown in FIG. 2A, an article A1 is located on a carrying platform C. A worker W performs a predetermined task on the article A1. The article A1 is a semifinished product, a unit used in a product, etc. The imaging device 10 acquires an image by imaging the worker W and the article A1. FIG. 2B shows an image IMG acquired by the imaging device 10.

Favorably, the imaging device 10 is mounted to a wall, a ceiling, etc., and images the worker W and the article A1 from above. The worker W and the article A1 are easily imaged thereby. The orientation of the imaging by the imaging device 10 may be directly downward or may be tilted with respect to the vertical direction. The imaging device 10 repeatedly acquires images. Or, the imaging device 10 may acquire a video image. In such a case, still images are repeatedly cut out from the video image. The imaging device 10 stores the images or the video image in the storage device 30.

The processing device 20 accesses the storage device 30 and acquires the image acquired by the imaging device 10. The processing device 20 estimates the pose of the worker W based on an image of the worker W. For example, the processing device 20 inputs the image to a pose estimation model prepared beforehand. The pose estimation model is pretrained to estimate the pose of a person in an image according to the input of the image. The processing device 20 acquires an estimation result of the pose estimation model. For example, the pose estimation model includes a neural network. It is favorable for the pose estimation model to include a convolutional neural network (CNN). OpenPose, DarkPose, CenterNet, etc., can be used as the pose estimation model.

FIG. 3 shows the result of pose estimation performed on the image shown in FIG. 2B. As shown in FIG. 3, the pose estimation estimates the position of multiple joints 100 of the worker W. The processing device 20 generates first graph data based on the estimated pose. The first graph data has a graph-type data structure. The first graph data includes multiple nodes and multiple edges. Nodes that are associated with each other are connected to each other by edges.

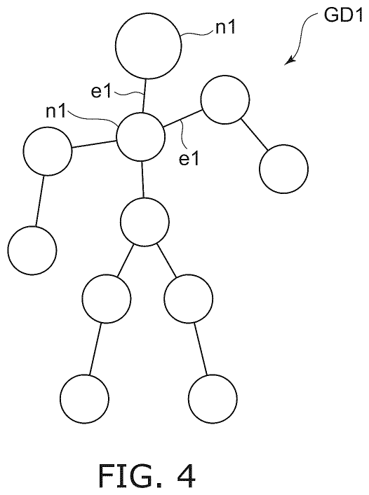

FIG. 4 is a schematic view illustrating the structure of the first graph data.

As shown in FIG. 4, first graph data GD1 includes multiple first nodes n1 and multiple first edges e1. The multiple first nodes n1 correspond respectively to multiple joints of the worker. The multiple first edges e1 correspond respectively to multiple skeletal parts of the worker. In the example shown in FIG. 4, the positions of the ankles, knees, lower back, chest, wrists, elbows, and head are estimated based on the image; and the multiple first nodes n1 that correspond to these parts are set. The multiple first edges e1 that correspond to skeletal parts connecting these joints are set. Accordingly, edges are not set between joints that are not actually connected. For example, the node of the wrist and the node of the elbow are connected by an edge, but the node of the wrist and the node of the lower back are not connected.

The first graph data GD1 may include more first nodes and first edges than those of the illustrated example. For example, first nodes that correspond to the neck, shoulders, fingers, etc., and first edges that correspond to these first nodes also may be set. The accuracy of the task estimation can be further increased by increasing the number of nodes. The number of nodes that 20 are set is modifiable as appropriate according to the processing capacity of the processing device 20.

The processing device 20 inputs the first graph data to a neural network, and acquires the output result from the neural network. The neural network includes a graph neural network (GNN) to be able to process graph data.

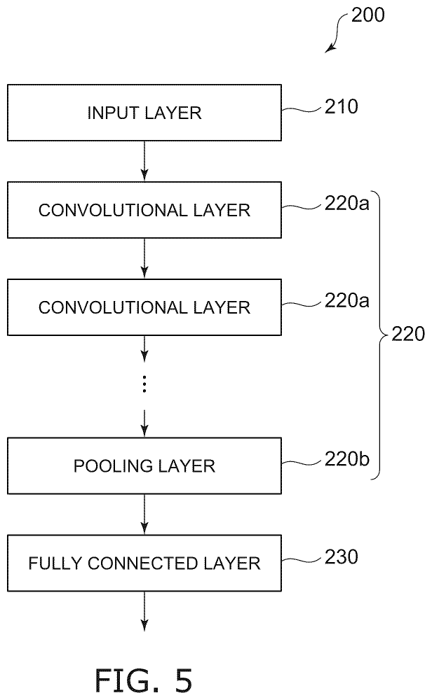

FIG. 5 is a schematic view illustrating the structure of a neural network.

For example, the neural network 200 shown in FIG. 5 is used to estimate the task. The neural network 200 includes an input layer 210, a GNN 220, and a fully connected layer 230. The GNN 220 includes multiple convolutional layers 220a and a pooling layer 220b. The first graph data GD1 is input to the input layer 210. The size of the input layer 210 is set according to the number of nodes of the first graph data GD1 and the number of edges of the first graph data GD1.

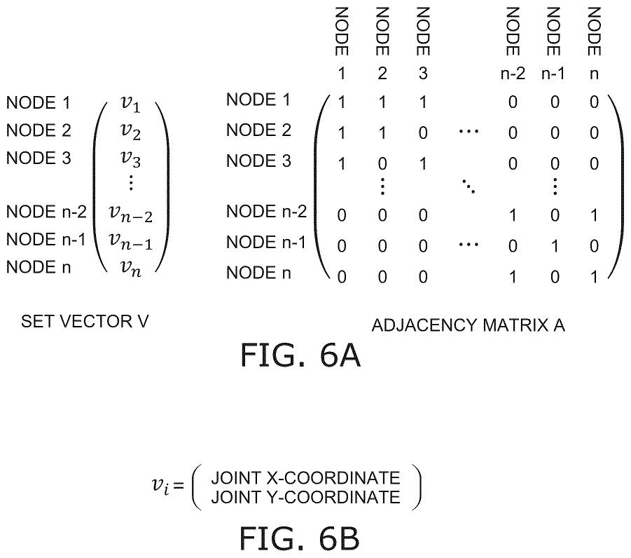

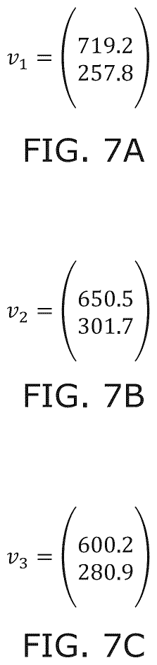

FIG. 6A illustrates the specific structure of the first graph data. FIG. 6B illustrates a feature vector. FIGS. 7A to 7C show specific examples of feature vectors.

As shown in FIG. 6A, the first graph data includes a set vector V and an adjacency matrix A. The set vector V includes values of the multiple nodes. Each node is represented by a feature vector v. As shown in FIG. 6B, the feature vector v includes the two values of the X-coordinate of the joint and the Y-coordinate of the joint.

As an example, FIGS. 7A to 7C respectively show a feature vector v₁ corresponding to the node of the left wrist, a feature vector v₂ corresponding to the node of the left elbow, and a feature vector v₃ corresponding to the node of the chest. The feature vector v₁ includes the X-coordinate of the left wrist and the Y-coordinate of the left wrist. The feature vector v₂ includes the X-coordinate of the left elbow and the Y-coordinate of the left elbow. The feature vector v₃ includes the X-coordinate of the chest and the Y-coordinate of the chest. The feature vectors v₁ to v₃ are examples of first nodes n1.

In the adjacency matrix A shown in FIG. 6A, the associations between the nodes are represented by “0” or “1”. In other words, the presence of each edge is represented by the value of “0” or “1”. “O” indicates that an edge is not present. “1” indicates that an edge is present.

In the GNN 220, each convolutional layer 220a convolves each feature vector v by Formula 1 below. In Formula 1, vᵢ is the initial feature vector of the ith node. vi^{conv(t)} is the updated feature vector of the ith node, and is obtained by the tth convolution. A(i) is the set of the feature vector of the ith node of the set vector V and the feature vector of the nodes defined by the adjacency matrix A as being adjacent to the ith node. Here, “adjacent” means connected by an edge. W(t) is the weight updated t times. The output result of the convolutional layers 220a is further reduced by the pooling layer 220b. The output result of the pooling layer 220b is converted into one-dimensional data by the fully connected layer 230. The output result of the fully connected layer 230 corresponds to the estimation result of the task.

$${v}_{i}^{conv ( t )} = Re LU ( {\sum }_{{v}_{j}^{conv ( t - 1 )} ∈ A ( i )} W ( t ) \cdot {v}_{j}^{conv ( t - 1 )} ) \qquad [ Formula 1 ]$$

$${v}_{j}^{conv ( 0 )} = {v}_{j}$$

$$Re LU ( x ) = \{ \begin{matrix}x ( x \geq 0 ) \\ 0 ( x < 0 )\end{matrix}$$

### Processing Method

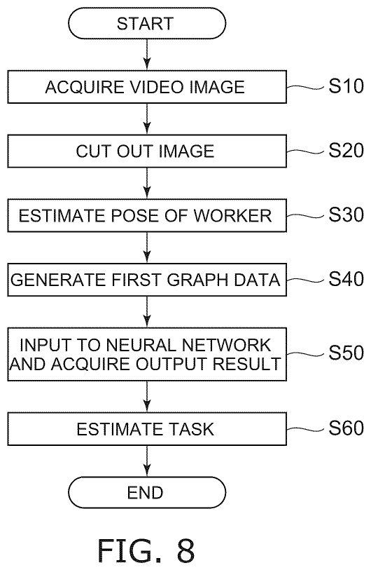

FIG. 8 is a flowchart showing an example of a processing method according to the embodiment.

As shown in FIG. 8, the imaging device 10 acquires a video image by imaging a worker and an article (step S10). The processing device 20 cuts out an image from the video image (step S20). The processing device 20 estimates the pose of the worker based on the image (step S30). The processing device 20 generates first graph data based on the estimated pose of the worker (step S40). The processing device 20 inputs the first graph data to a neural network, and acquires the output result from the neural network (step S50). The processing device 20 uses the output result from the neural network to estimate the task being performed by the worker (step S60).

### Training

The neural network that is used to estimate the task is pretrained. Multiple sets of training data are used in the training. Each set of training data includes input data and teaching data (labels). The input data has a graph structure, and is generated using an image of the actual task. The input data may be prepared using a synthesized image representing the actual task. The method for generating the graph data described above is applicable to generate the input data. The teaching data is labels indicating the task corresponding to the input data. The intermediate layers of the neural network are trained to output teaching data according to the input of the input data.

### Output Example

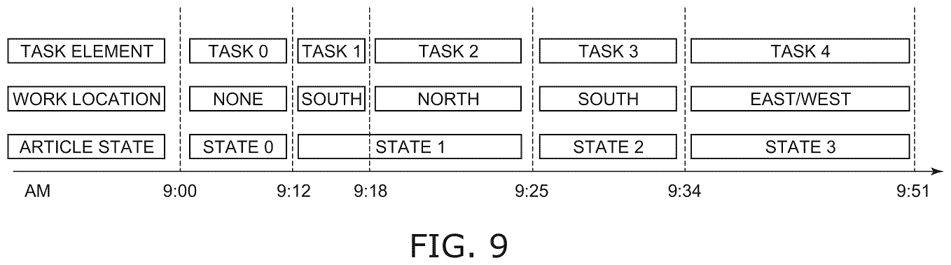

FIG. 9 is a schematic view illustrating an output result of the processing system according to the embodiment.

In FIG. 9, the horizontal direction shows time. The vertical direction shows the estimation results of the article state and work location based on the image at each time. The uppermost row shows the task estimated based on the article state and work location.

While the task is being performed, images of the state of the task are repeatedly acquired. The processing device 20 repeats an estimation of the task based on the images. The task that is being performed by the worker at each time is estimated thereby. For example, the processing system 1 estimates the task in real-time while the task is being performed.

Advantages of the embodiment will now be described.

Various methods have been tried to estimate the task being performed. Generally, the same movement is repeated in the task; and the change of the movement is small. Therefore, there are many cases where estimating a task is more difficult than estimating a body action such as running, jumping, bending, etc. To estimate a task with high accuracy, there is a method of mounting multiple sensors to the body of the worker. In this method, the task is estimated by determining fine movements of the worker based on the data of the sensors. In such a case, costs are high because many expensive sensors are necessary. Also, it takes time and effort to mount the sensors to the worker; and the sensors may interfere with the task.

For this problem, the processing system 1 according to the embodiment uses the pose of the worker to estimate the task being performed. The pose of the worker changes according to the task being performed. Therefore, the task can be estimated by using information of the pose.

According to the embodiment of the invention, the graph data is generated using the information of the pose to further increase the estimation accuracy. The graph data includes multiple nodes and multiple edges. The edges indicate that the nodes are associated with each other. For example, connections between body joints are represented by edges. The processing system 1 obtains the estimation result of the task by inputting the graph data to a GNN.

Some joints of the body are connected to each other by skeletal parts. The movements of such joints are associated with each other. On the other hand, there is little movement association between joints that are not connected by skeletal parts. For example, the body includes joint combinations having high movement association such as the combination of a wrist and an elbow, the combination of an ankle and a knee, etc. On the other hand, there are joint combinations having low movement association such as the combination of an ankle and a wrist, etc. By using the graph data, the associations between the nodes can be represented. Namely, edges can be used to assign weights to the nodes. When the data used to estimate the task does not have a graph structure, the association between the data is trained and calculated indiscriminately. By using graph data, the associations between the nodes can be considered, and a more accurate estimation result can be obtained.

The pose of the worker also can be estimated based on the image. The task can be estimated without mounting sensors to the worker. Accordingly, the task of the worker can be estimated without obstructing the task. The cost necessary to estimate the task also can be reduced.

According to the embodiment of the invention, the task can be estimated more easily and with higher accuracy.

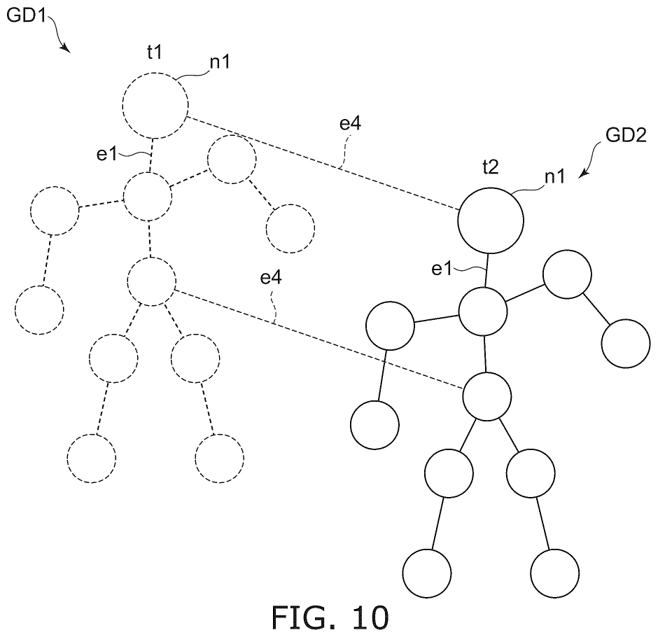

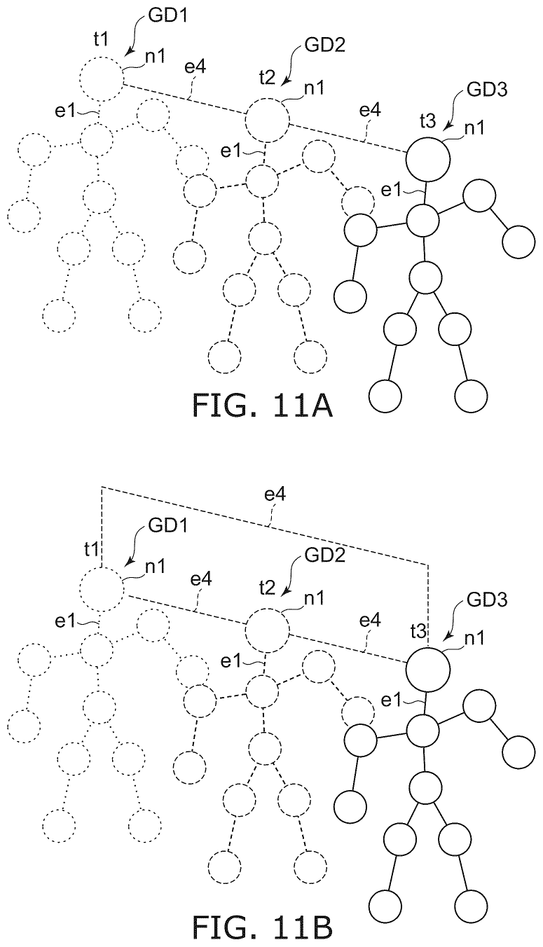

FIGS. 10, 11A, and 11B are schematic views illustrating another structure of the graph data.

Changes of the node values over time may be used in the estimation. For example, as shown in FIG. 10, the first graph data GD1 is generated based on an image (a first image) obtained at a time t1. The first graph data GD1 includes the multiple first nodes n1 and the multiple first edges e1. Second graph data GD2 is generated based on an image (a second image) obtained at a time t2 after the time t1. Similarly to the first graph data GD1, the second graph data GD2 includes the multiple first nodes n1 and the multiple first edges e1. The processing device 20 respectively connects the multiple first nodes n1 of the first graph data GD1 and the multiple first nodes n1 of the second graph data GD2 with multiple edges e4. FIG. 10 shows only some of the edges e4; the other edges e4 are not illustrated.

As shown in FIG. 11A, images may be acquired respectively at three or more times t1 to t3; and the first to third graph data GD1 to GD3 may be generated respectively based on the three images. For example, the edges e4 are used to mutually connect the corresponding first nodes n1 between the first graph data GD1 and the second graph data GD2 based on images having mutually-adjacent imaging times. The edges e4 are used to mutually connect the corresponding first nodes n1 between the second graph data GD2 and the third graph data GD3 based on images having mutually-adjacent imaging times.

One set of graph data may be selected from multiple sets of graph data; and a node of the selected graph data and a node of other graph data may be connected. For example, the third graph data GD3 is selected from the first to third graph data GD1 to GD3. As shown in FIG. 11B, the first nodes n1 of the first and second graph data GD1 and GD2 may be connected to the first nodes n1 of the third graph data GD3. In such a case, the first nodes n1 of the first graph data GD1 and the first nodes n1 of the second graph data GD2 are not connected by edges.

By representing the temporal change of each node in a graph structure, the accuracy of the task estimation can be further increased.

In the example shown in FIG. 11A or FIG. 11B, all of the temporally consecutive images may not be utilized to generate the graph data. For example, when ten images are acquired between the times t1 to t10, ten sets of graph data may be generated from the ten images; and the nodes of the ten sets of graph data may be connected to each other. A part of the images may be selected from the ten images. In such a case, graph data is generated based on the selected images; and the nodes of the selected images are connected to each other. In any case, the multiple sets of graph data that are connected to each other are input to the neural network 200.

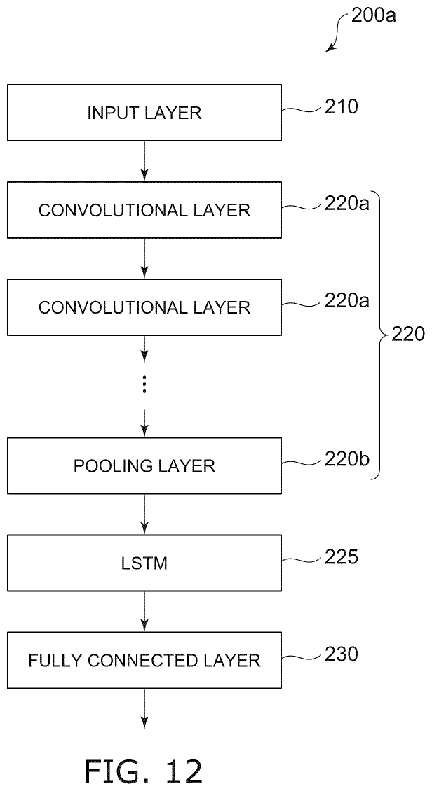

FIG. 12 is a schematic view illustrating another structure of a neural network.

The neural network may include a long short-term memory (LSTM) network to use the temporal change of the nodes in the estimation. Compared to the neural network 200 shown in FIG. 5, the neural network 200a shown in FIG. 12 further includes an LSTM network 225. The data (the values) that are output from the GNN 220 are input to the LSTM network 225. The data that is output from the LSTM network 225 is input to the fully connected layer 230; and the estimation result of the task from the fully connected layer 230 is output.

### LSTM Network

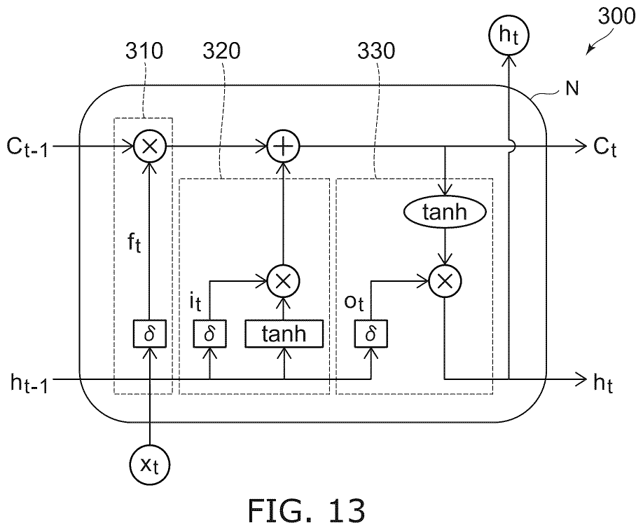

FIG. 13 is a schematic view illustrating the specific structure of the LSTM network.

As shown in FIG. 13, each neuron N of the LSTM network 300 includes a forget gate 310, an input gate 320, and an output gate 330. In FIG. 13, xₜ represents the input value to the neuron N at a time t. Cₜ represents the state of the neuron N at the time t. fₜ represents the output value of the forget gate 310 at the time t. iₜ represents the output value of the input gate at the time t. oₜ represents the output value of the output gate at the time t. hₜ represents the output value of the neuron N at the time t. fₜ, iₜ, Cₜ, oₜ, and hₜ are respectively represented by the following Formulas 2 to 6.

$${f}_{t} = σ ( {W}_{f} \cdot [ {h}_{t - 1} , {x}_{t} ] + {b}_{f} ) \qquad [ Formula 2 ]$$

$${i}_{t} = σ ( {W}_{i} \cdot [ {h}_{t - 1} , {x}_{t} ] + {b}_{i} ) \qquad [ Formula 3 ]$$

$${C}_{t} = {f}_{t} * {C}_{t - 1} + {i}_{t} * tanh ( {W}_{c} \cdot [ {h}_{t - 1} , {x}_{t} ] + {b}_{c} ) \qquad [ Formula 4 ]$$

$${o}_{t} = σ ( {W}_{o} \cdot [ {h}_{t - 1} , {x}_{t} ] + {b}_{o} \qquad [ Formula 5 ]$$

$${h}_{t} = {o}_{t} * tanh ( {C}_{t} ) \qquad [ Formula 6 ]$$

### Example

The inventors of the application verified the accuracy of the task estimation for the embodiment described above. First, the imaging device 10 imaged the state of the task. The frame rate of the imaging device 10 was 25 fps. In other words, the imaging device 10 acquired twenty-five images per second. To estimate the task being performed at the time t, the processing device 20 acquired images acquired at times from the time t to the time t+99. The processing device 20 estimated the poses of the worker based on the one hundred images that were acquired. The processing device 20 generated graph data based on the estimated poses of the images. The processing device 20 used edges to mutually connect the graph data based on images having mutually-adjacent imaging times as shown in FIG. 11A. The processing device 20 input the graph data thus obtained to the neural network 200 shown in FIG. 5. The processing device 20 estimated the task being performed at the time t based on the result output from the neural network 200.

Separately from the estimation described above, the processing device 20 generated one hundred sets of graph data by using the estimated poses of one hundred images. The processing device 20 sequentially input the one hundred sets of graph data to the neural network 200a shown in FIG. 12. The processing device 20 estimated the task being performed at the time t based on the result output from the neural network 200a.

Multiple images that were imaged at mutually-different times were used in the method that used the neural network 200 shown in FIG. 5 and the graph data shown in FIG. 11A, and in the method that used the neural network 200a shown in FIG. 12 and multiple sets of the graph data shown in FIG. 4. These methods had in common that the temporal change of the nodes can be utilized in the estimation.

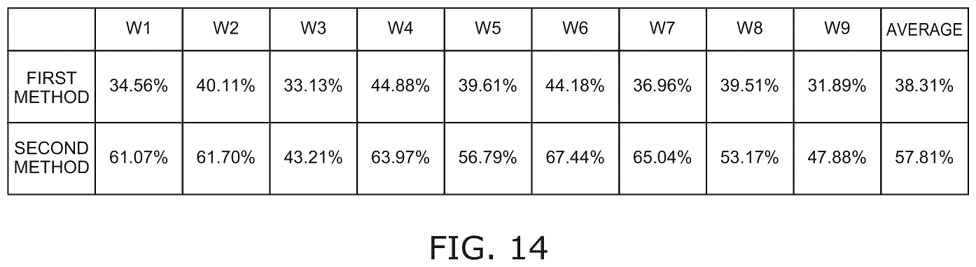

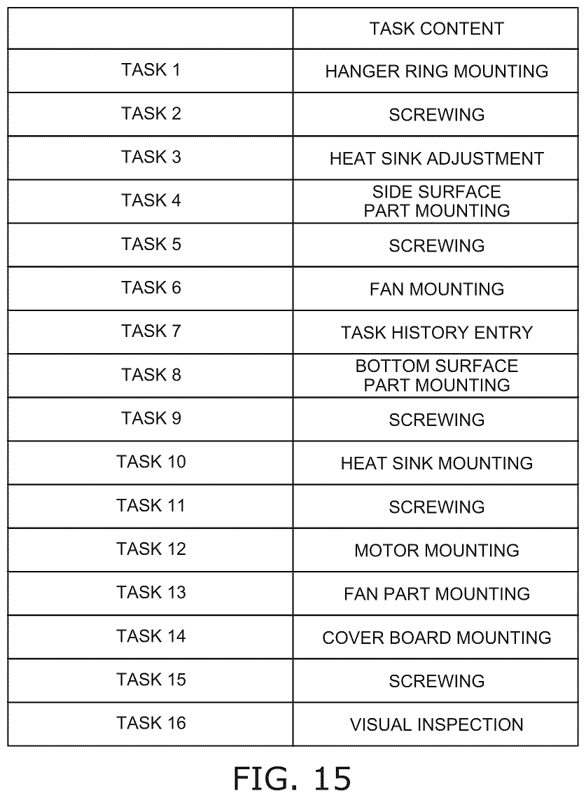

FIG. 14 is a table showing the accuracy of the estimation results of the tasks. FIG. 15 is a table illustrating the tasks performed.

Nine workers W1 to W9 shown in FIG. 14 each performed tasks. Each worker sequentially performed the tasks “1” to “16” shown in FIG. 15. The first method and the second method were used to estimate the tasks by using the images of the workers performing the tasks.

The first method was the estimation method that used the neural network 200 shown in FIG. 5 and the graph data shown in FIG. 11A. The second method was the estimation method that used the neural network 200a shown in FIG. 12 and multiple sets of the graph data shown in FIG. 4. The same images were used in the estimation of the task by the first method and the estimation of the task by the second method. The number of the convolutional layers 220a was set to two layers for the neural networks 200 and 200a. The accuracy (the correct solution rate) of the estimation was determined for the sixteen tasks for each worker and each method. The results are shown in FIG. 14.

The results of the experiment show that both methods had in common the ability to utilize the temporal change of the nodes in the estimation, but there was a large difference in the estimation accuracy. Specifically, according to the second method, the estimation accuracies of the tasks each were improved more than 10% compared to the first method. For some of the tasks, the estimation accuracies of the tasks according to the second method were improved more than 25% compared to the first method.

The following is inferred from these results. GNNs are effective for training spatial associations such as the skeletal part connections. Recurrent-type neural networks such as LSTM networks are more effective than GNNs for training associations between temporal data. In other words, it is effective to train associations between spatial nodes by using a GNN, and effective to train associations between temporal nodes by using an LSTM network. It is inferred that the estimation accuracy can be increased by dividing the roles between a GNN and an LSTM network.

In the processing system 1, auxiliary sensors may be mounted to the body of the worker. For example, an acceleration, angular velocity, etc., of a part of the body may be used in addition to the pose of the worker, the state of the article, and the work location to estimate the task. In such a case as well, the number of necessary sensors can be less than when the task is estimated using only sensors.

Other information in addition to the pose may be estimated based on the image. For example, the processing device 20 estimates at least one selected from the state of the article and the work location on the article based on the image. The processing device 20 generates the first graph data based on the at least one selected from the pose, the state, and the work location. The processing device 20 inputs the first graph data to the neural network, and uses the output result to estimate the task being performed.

The state (the appearance) of the article changes as the task proceeds. The location on the article worked on by the worker also changes according to the task being performed. Accordingly, the accuracy of the task estimation can be further improved by using such information.

A state estimation model is used to estimate the state of the article. The processing device 20 inputs the image to the state estimation model. The processing device 20 acquires the estimation result of the state estimation model. The state estimation model is pretrained to estimate the state of the article visible in the image according to the input of the image. The state estimation model is trained using images of the article and labels indicating the state of the article. For example, the state estimation model includes a neural network. It is favorable for the state estimation model to include a convolutional neural network (CNN).

Template matching may be used to estimate the state of the article. The processing device 20 compares the image with multiple template images prepared beforehand. The state of the article is associated with each template image. The processing device 20 calculates similarities between the image and each template image. The processing device 20 extracts the template image for which the maximum similarity is obtained. The processing device 20 estimates the state associated with the extracted template image to be the state of the article visible in the image.

A work location estimation model is used to estimate the work location on the article. The processing device 20 inputs the image to the work location estimation model. The processing device 20 acquires the estimation result of the work location estimation model. The work location estimation model is pretrained according to the input of the image to estimate the work location on which the worker is working. The work location estimation model is trained using images of the article and labels indicating the work locations in the image. For example, the work location estimation model includes a neural network. It is favorable for the work location estimation model to include a CNN.

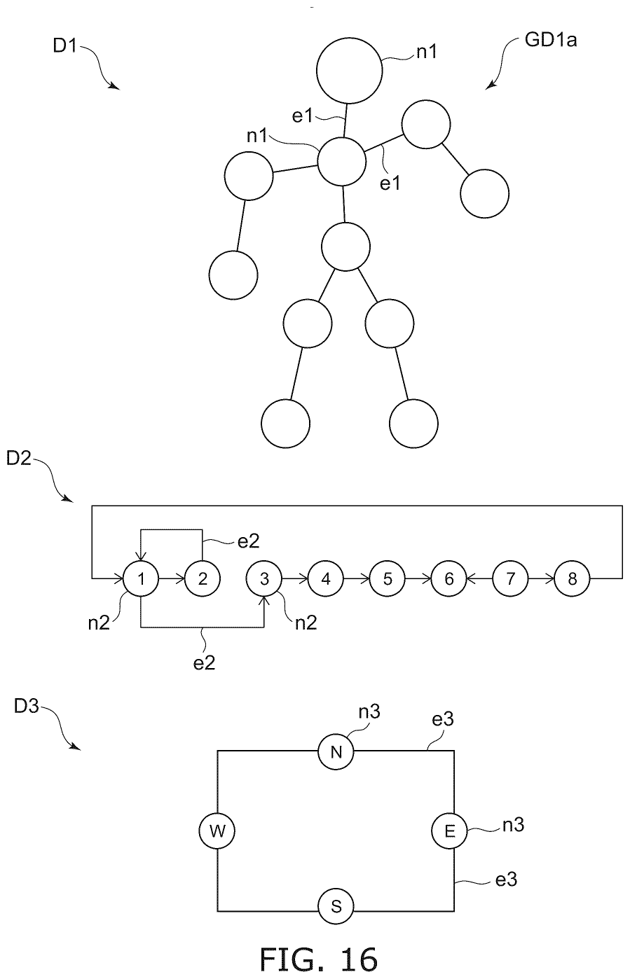

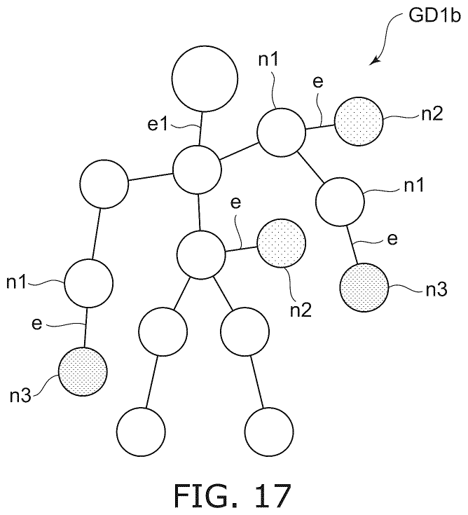

FIGS. 16 and 17 are schematic views illustrating a structure of the first graph data.

The processing device 20 generates the first graph data based on at least one selected from the state and the work location in addition to the pose. For example, first graph data GD1a shown in FIG. 16 includes first data D1, second data D2, and third data D3. The first data D1, the second data D2, and the third data D3 are separated from each other, and are not connected by edges.

The first data D1 is generated based on the estimation result of the pose. The first data D1 includes the multiple first nodes n1 and the multiple first edges e1. The multiple first nodes n1 correspond respectively to multiple joints of the worker. The multiple first edges e1 correspond respectively to multiple skeletal parts of the worker.

The second data D2 is generated based on the estimation result of the state. The second data D2 includes multiple second nodes n2 and multiple second edges e2. The multiple second nodes n2 correspond respectively to multiple states that the article may be in. The multiple second edges e2 correspond respectively to transitions of the state of the article. In the example shown in FIG. 16, eight second nodes n2 are set because the article can be in eight states. Nine second edges e2 are set to correspond to the possible transitions between these states. For example, a transition from a first state to a second state, a transition from the second state to the first state, a transition from the first state to a third state, etc., may occur. The second edges e2 are set to correspond respectively to these transitions.

The third data D3 is generated based on the estimation result of the work location. The third data D3 includes multiple third nodes n3 and multiple third edges e3. The multiple third nodes n3 correspond respectively to multiple locations of the article which may be worked on. The multiple third edges e3 respectively indicate the associations between the work locations. For example, locations that may be transitioned between during the actual task are connected to each other by edges. In the example shown in FIG. 16, the north node and the east node are connected by an edge. This edge indicates that the work location may transition from the north location to the east location, or from the east location to the north location. Similarly, edges are set respectively between the east node and the south node, between the south node and the west node, and between the west node and the north node. These edges indicate that the work location may transition between these nodes. Edges are not set between the north location and the south location or between the east location and the west location. This configuration indicates that the work location does not transition between the north location and the south location or between the east location and the west location.

The first graph data GD1a shown in FIG. 16 is input to the neural network 200 shown in FIG. 5. The processing device 20 estimates the task being performed by using the result output from the neural network 200.

As in first graph data GD1b shown in FIG. 17, the first nodes n1 and the second nodes n2 may be connected by edges e; and the first nodes n1 and the third nodes n3 may be connected by other edges e. The second nodes n2 are connected with the first nodes n1 that have associations. The third nodes n3 are connected with the first nodes n1 that have associations.

As an example, when the association between the position of the lower back of the worker and some state of the article is greater than the association of another combination, the first node n1 of the lower back and the second node n2 of this state of the article are connected by the edge e. When the association between the position of the left elbow of the worker and another state of the article is greater than the association of another combination, the first node n1 of the left elbow and the second node n2 of the other state of the article are connected by the edge e. When some location of the article is worked on mainly by the right hand of the worker, the third node n3 that corresponds to the location is connected with the first node n1 corresponding to the right hand by the edge e. When another location of the article is worked on mainly by the left hand of the worker, the third node n3 that corresponds to the other location is connected with the first node n1 corresponding to the left hand by the edge e.

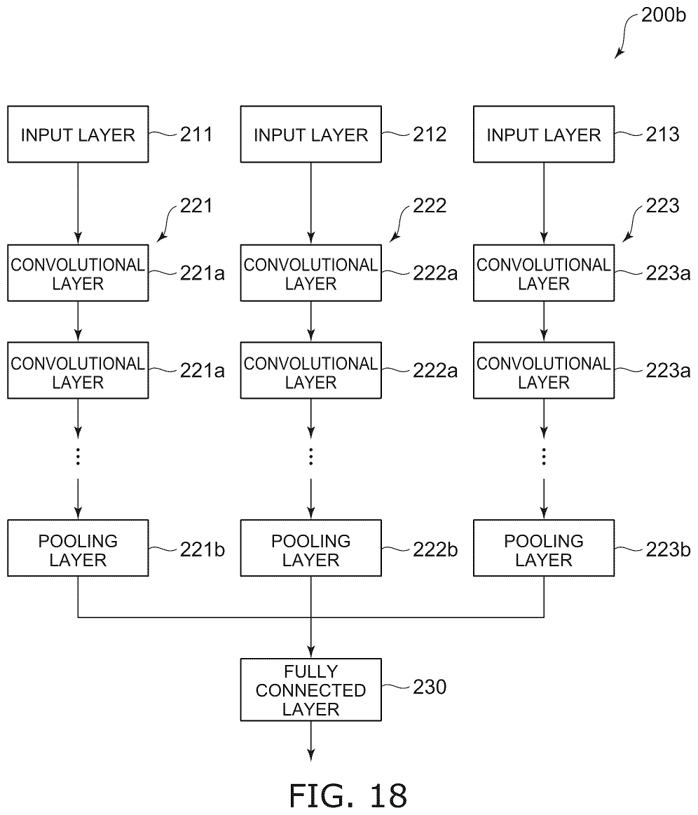

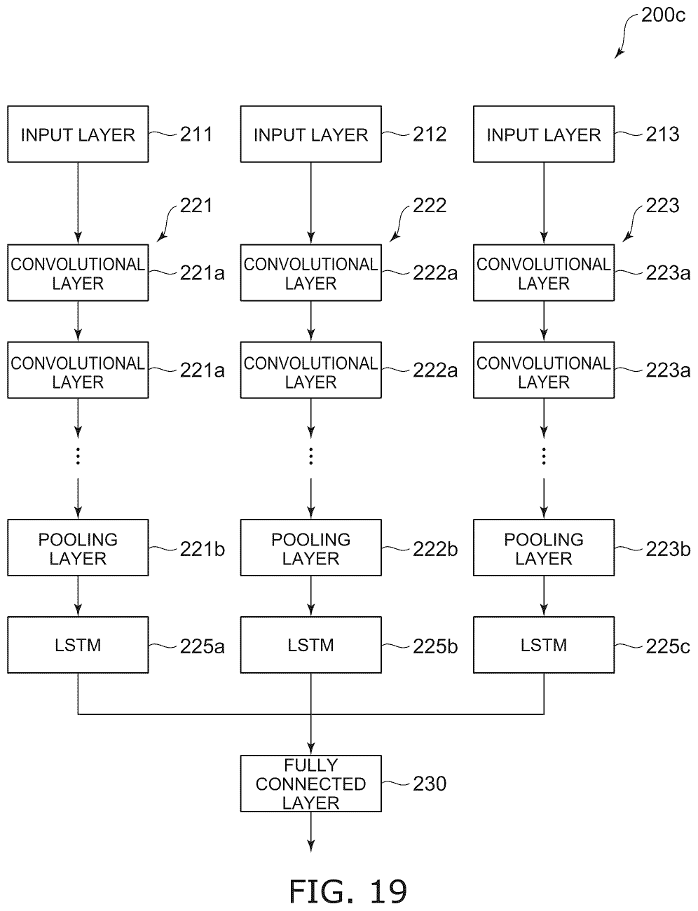

FIGS. 18 and 19 are schematic views illustrating another structure of a neural network.

As shown in FIG. 18, the neural network 200b may include input layers 211 to 213, GNNs 221 to 223, and the fully connected layer 230. The first data D1 that is related to the pose is input to the input layer 211. The GNN 221 includes convolutional layers 221a and a pooling layer 221b, and processes the first data D1. The second data D2 that is related to the state of the article is input to an input layer 212. The GNN 222 includes convolutional layers 222a and a pooling layer 222b, and processes the second data D2. The third data D3 that is related to the work location on the article is input to the input layer 213. The GNN 223 includes convolutional layers 223a and a pooling layer 223b, and processes the third data D3. Similarly to the convolutional layer 220a, the convolutional layers 221a to 223a convolve the feature vectors of the nodes. Similarly to the pooling layer 220b, the pooling layers 221b to 223b reduce the convolved feature vectors. The output results of the GNNs 221 to 223 are connected in the fully connected layer 230. The fully connected layer 230 outputs the estimation result of the task.

Similarly to the example shown in FIG. 6A, the second node n2 corresponding to the state of the article and the third node n3 corresponding to the work location on the article are represented by feature vectors. The second edge e2 and the third edge e3 are represented by the value of “0” or “1”.

Sets of graph data may be generated by estimating the pose, the state, and the work location based on multiple images. In such a case, as shown in FIG. 10, FIG. 11A, or FIG. 11B, the multiple sets of graph data are connected by edges and input to the neural network 200 shown in FIG. 5. The multiple sets of graph data may be sequentially input to the neural network 200a including the LSTM network 225.

Compared to the neural network 200b, the LSTM networks 225a to 225c may be further included as in a neural network 200c shown in FIG. 19. The data that is output from the GNNs 221 to 223 is input respectively to the LSTM networks 225a to 225c. The data that is output from the LSTM networks 225a to 225c is input to the fully connected layer 230; and the estimation result of the task is output from the fully connected layer 230.

### Processing Method

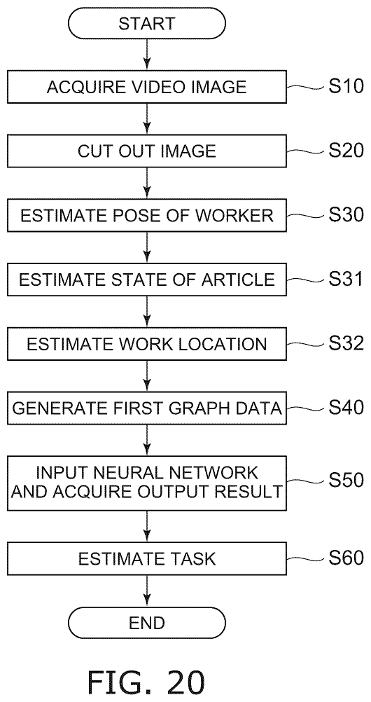

FIG. 20 is a flowchart showing another example of the processing method according to the embodiment.

First, steps S10 to S30 are performed similarly to the flowchart shown in FIG. 8. The processing device 20 estimates the state of the article based on the image (step S31). The processing device 20 estimates the work location on the article based on the image (step S32). The processing device 20 generates the first graph data based on the pose of the worker, the state of the article, and the work location on the article (step S40). The processing device 20 inputs the first graph data to the neural network, and acquires the output result from the neural network (step S50). The processing device 20 uses the output result from the neural network to estimate the task being performed by the worker (step S60).

By using information of the state of the article and the work location on the article in addition to the pose, the accuracy of the task estimation can be further increased.

In particular, complex fine motions arise when handling (manufacturing) an article. Also, similar motions may arise even when the tasks are different from each other. Thousands to tens of thousands of parts may be assembled when manufacturing a large made-to-order product (an indented product). Therefore, the number of tasks also is extremely high. The accuracy may degrade when the task is estimated based on only the pose. By using at least one selected from the state and the work location in addition to the pose, the task can be estimated with higher accuracy.

The three sets of information of the pose of the worker, the state of the article, and the work location on the article are used to estimate the task in the examples described above. Embodiments of the invention are not limited to such examples; the pose of the worker and one selected from the state and the work location may be used to estimate the task. For example, when the state (the appearance) of the article changes as the task proceeds, the task can be estimated with high accuracy even without information of the work location. When the work location changes as the task proceeds, the task can be estimated with high accuracy even without information of the state of the article.

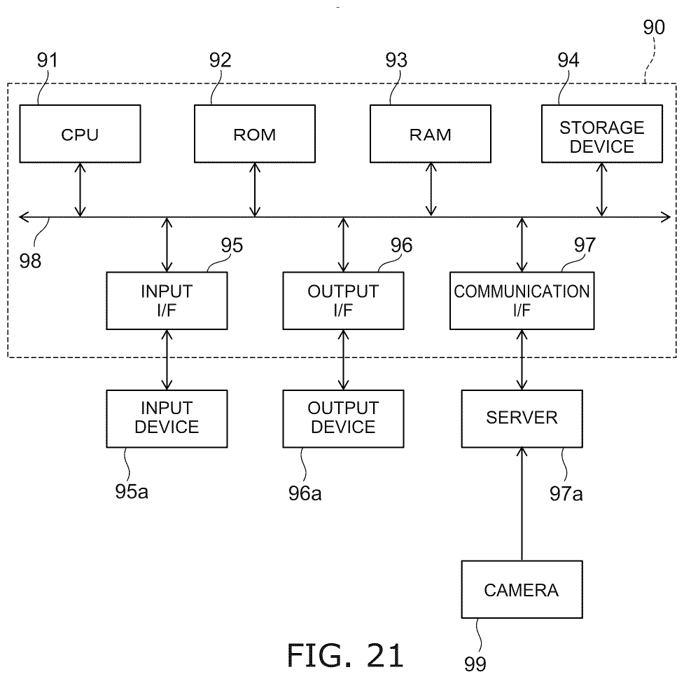

FIG. 21 is a schematic view illustrating a hardware configuration.

For example, the processing device 20 includes the hardware configuration shown in FIG. 21. A computer 90 shown in FIG. 21 includes a CPU 91, ROM 92, RAM 93, a memory device 94, an input interface 95, an output interface 96, and a communication interface 97.

The ROM 92 stores programs that control the operations of the computer. Programs that are necessary for causing the computer to realize the processing described above are stored in the ROM 92. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the memory device 94. When executing the programs, the CPU 91 executes various processing by controlling configurations via a system bus 98.

The memory device 94 stores data necessary for executing the programs and/or data obtained by executing the programs.

The input interface (I/F) 95 connects the computer 90 and an input device 95a. The input I/F 95 is, for example, a serial bus interface such as USB, etc. The CPU 91 can read various data from the input device 95a via the input I/F 95.

The output interface (I/F) 96 connects the computer 90 and an output device 96a. The output I/F 96 is, for example, an image output interface such as Digital Visual Interface (DVI), High-Definition Multimedia Interface (HDMI (registered trademark)), etc. The CPU 91 can transmit data to the output device 96a via the output I/F 96 and cause the output device 96a to display an image.

The communication interface (I/F) 97 connects the computer 90 and a server 97a outside the computer 90. The communication I/F 97 is, for example, a network card such as a LAN card, etc. The CPU 91 can read various data from the server 97a via the communication I/F 97. A camera 99 images an article and stores the image in the server 97a.

The memory device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor, a projector, a speaker, and a printer. A device such as a touch panel that functions as both the input device 95a and the output device 96a may be used.

The memory device 94 can be used as the storage device 30. The camera 99 can be used as the imaging device 10.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD+R, DVD+RW, etc.), semiconductor memory, or another non-transitory computer-readable storage medium.

For example, the information that is recorded in the recording medium can be read by the computer (or an embedded system). The recording format (the storage format) of the recording medium is arbitrary. For example, the computer reads the program from the recording medium and causes a CPU to execute the instructions recited in the program based on the program. In the computer, the acquisition (or the reading) of the program may be performed via a network.

The embodiments may include the following features.

### (Feature 1)

A processing system, configured to:
generate first graph data based on a pose of a worker, the pose being estimated based on a first image of the worker, the first graph data including
   a plurality of first nodes corresponding respectively to a plurality of joints of the worker, and
   a plurality of first edges corresponding respectively to a plurality of skeletal parts of the worker; and
by inputting the first graph data to a neural network including a graph neural network (GNN) and by using a result output from the neural network, estimate a task being performed by the worker.

### (Feature 2)

The system according to Feature 1, further configured to:
generate second graph data based on a pose of the worker estimated based on a second image acquired after the first image, the second graph data including the plurality of first nodes and the plurality of first edges; and
estimate the task by inputting the second graph data to the neural network after the inputting of the first graph data, and by using the result output from the neural network.

### (Feature 3)

The system according to Feature 2, wherein
the neural network includes the GNN, and a long short-term memory (LSTM) network to which an output from the GNN is input.

### (Feature 4)

The system according to Feature 1, further configured to:
generate second graph data based on a pose of the worker estimated based on a second image acquired after the first image, the second graph data including a plurality of nodes and a plurality of edges; and
estimate the task by inputting graph data to the neural network and by using the result output from the neural network, the plurality of first nodes of the first graph data and the plurality of nodes of the second graph data being respectively connected by a plurality of edges in the graph data.

### (Feature 5)

The system according to any one of Features 1 to 4, further configured to:
generate the first graph data based on a state of an article in addition to the pose,
the article being visible in the first image,
the state of the article being estimated based on the first image, and
the first graph data including:
   the plurality of first nodes;
   the plurality of first edges; and
   a plurality of second nodes corresponding respectively to a plurality of the states that the article may be in.

### (Feature 6)

The system according to any one of Features 1 to 4, further configured to:
generate the first graph data based on a work location on an article in addition to the pose,
the article being visible in the first image,
the work location on the article being estimated based on
   the first image,
the first graph data including:
   the plurality of first nodes;
   the plurality of first edges; and
   a plurality of third nodes corresponding respectively to a plurality of locations of the article.

### (Feature 7)

The system according to any one of Features 1 to 6, wherein
the plurality of first nodes included in the first graph data represents coordinates of the plurality of joints of the first image.

### (Feature 8)

The system according to any one of Features 1 to 7, further configured to:
cause a display device to display
   a time at which the first image is acquired, and
   an estimation result of the task at the time.

### (Feature 9)

A processing method, comprising:
causing a processing device to
   generate first graph data based on a pose of a worker, the pose being estimated based on a first image of the worker, the first graph data including
      a plurality of first nodes corresponding respectively to a plurality of joints of the worker, and
      a plurality of first edges corresponding respectively to a plurality of skeletal parts of the worker, and
   by inputting the first graph data to a neural network including a graph neural network (GNN) and by using a result output from the neural network, estimate a task being performed by the worker.

### (Feature 10)

A program causing the processing device to perform the method according to Feature 9.

### (Feature 11)

A non-transitory computer-readable storage medium storing a program,
the program, when executed by the processing device, causing the processing device to perform the method according to Feature 9.

According to the embodiments described above, a processing system, a processing method, a program, and a storage medium are provided in which a task can be estimated more easily and with higher accuracy.

In the specification, “or” shows that “at least one” of items listed in the document can be adopted.

While certain embodiments of the inventions have been illustrated, these embodiments have been presented by way of example only, and are not intended to limit the scope of the inventions. These novel embodiments may be embodied in a variety of other forms; and various omissions, substitutions, modifications, etc., can be made without departing from the spirit of the inventions. These embodiments and their modifications are within the scope and spirit of the inventions and are within the scope of the inventions described in the claims and their equivalents. The embodiments described above can be implemented in combination with each other.

What is claimed is:

1. A processing system, configured to:
generate first graph data based on a pose of a worker, the pose being estimated based on a first image of the worker, the first graph data including
a plurality of first nodes corresponding respectively to a plurality of joints of the worker, and
a plurality of first edges corresponding respectively to a plurality of skeletal parts of the worker; and
by inputting the first graph data to a neural network including a graph neural network (GNN) and by using a result output from the neural network, estimate a task being performed by the worker.

2. The system according to claim 1, further configured to:
generate second graph data based on a pose of the worker estimated based on a second image acquired after the first image, the second graph data including the plurality of first nodes and the plurality of first edges; and
estimate the task by inputting the second graph data to the neural network after the inputting of the first graph data, and by using the result output from the neural network.

3. The system according to claim 2, wherein
the neural network includes the GNN, and a long short-term memory (LSTM) network to which an output from the GNN is input.

4. The system according to claim 1, further configured to:
generate second graph data based on a pose of the worker estimated based on a second image acquired after the first image, the second graph data including a plurality of nodes and a plurality of edges; and
estimate the task by inputting graph data to the neural network and by using the result output from the neural network, the plurality of first nodes of the first graph data and the plurality of nodes of the second graph data being respectively connected by a plurality of edges in the graph data.

5. The system according to claim 1, further configured to:
generate the first graph data based on a state of an article in addition to the pose,
the article being visible in the first image,
the state of the article being estimated based on the first image, and
the first graph data including:
the plurality of first nodes;
the plurality of first edges; and
a plurality of second nodes corresponding respectively to a plurality of the states that the article may be in.

6. The system according to claim 1, further configured to:
generate the first graph data based on a work location on an article in addition to the pose,
the article being visible in the first image,
the work location on the article being estimated based on the first image,
the first graph data including:
the plurality of first nodes;
the plurality of first edges; and
a plurality of third nodes corresponding respectively to a plurality of locations of the article.

7. The system according to claim 1, wherein
the plurality of first nodes included in the first graph data represents coordinates of the plurality of joints of the first image.

8. The system according to claim 1, further configured to:
cause a display device to display
a time at which the first image is acquired, and
an estimation result of the task at the time.

9. A processing method, comprising:
causing a processing device to
generate first graph data based on a pose of a worker, the pose being estimated based on a first image of the worker, the first graph data including
a plurality of first nodes corresponding respectively to a plurality of joints of the worker, and
a plurality of first edges corresponding respectively to a plurality of skeletal parts of the worker, and
by inputting the first graph data to a neural network including a graph neural network (GNN) and by using a result output from the neural network, estimate a task being performed by the worker.

10. A non-transitory computer-readable storage medium storing a program,
the program, when executed by the processing device, causing the processing device to perform the method according to claim 9.
